(19) United States
(12) Patent Application Publication
(10) Pub. No.: US 2013/0306031 A1
(43) Pub. Date: Nov. 21, 2013

(54) Pressure Control Valve Arrangement for a Fuel Line

(71) Applicant: Veritas AG, GeInhausen (DE)

(72) Inventor: Isa Coel, Frankfurt (DE)

(73) Assignee: Veritas AG, Gelnhausen (DE)

(21) Appl. No.: 13/870,062

(22) Filed: Apr. 25, 2013

(30) Foreign Application Priority Data
May 15, 2012 (DE) 10 2012 208 106.2

(51) Int. Cl. F02M 55/00; F02M 63/02

(52) U.S. Cl. CPC F02M 55/002; F02M 63/023
USPC 123/459; 137/512; 137/540

(57) ABSTRACT

The present invention concerns a pressure control valve system for a fuel line with a pressure line with a pressure control valve for maintaining a fuel pressure in the fuel line and a filling line for filling the fuel line with fuel, wherein an inlet of the pressure line is connected to an outlet of the filling line using fluid technology.

### BACKGROUND OF THE INVENTION

1. Field of the Invention

The present invention concerns a pressure control valve system for a fuel line.

2. Related Technology

In modern internal combustion engines, the injection valves of the internal combustion engine are supplied with fuel through a common fuel line (common rail system). Fuel that is not introduced into the particular injection valves is collected in a common fuel return line and is introduced again into a fuel inlet line.

In order to insure the function of the injection valves, a constant fuel pressure is maintained in the fuel return line with the aid of a pressure control valve. Before the initial operation of the internal combustion engine, the fuel return line is filled with fuel.

Publication DE 103 39 250 A1 describes a pressure control valve that can be used for maintaining the fuel pressure in a fuel line as well as for the initial filling of the fuel line.

### SUMMARY OF THE INVENTION

The invention simplifies the structure of a pressure control valve.

The present invention is based on the recognition that the structure of the present pressure control valves is complicated and prone to defects.

According to one embodiment, the task according to the invention is achieved by a pressure control valve system for a fuel line, with a pressure line with a pressure control valve to maintain a fuel pressure in the fuel line and a filling line for filling (initial filling) of the fuel line with fuel, in which an inlet of the pressure line is connected with an outlet of the filling line using fluid technology. As a result of this, for example, the technical advantage is achieved that the structure of the valve is simplified. A compact structure and good control characteristics are provided as well. The pressure control valve system installation is not position dependent; it requires low maintenance and is robust.

In an advantageous embodiment of the pressure control valve system, an inlet of the filling line is decoupled from an outlet of the pressure line, or an inlet of the filling line is connected with the outlet of the pressure line using fluid technology. As a result of this, for example, the technical advantage is achieved that the pressure line can be filled through a separate or a common fuel connection.

In a further advantageous embodiment of the pressure control valve system, the inlet direction of the filling line is opposite to the direction of passage of the pressure line from a fluid technology perspective. As a result of this, for example, the technical advantage is achieved that the back-flow of fuel is prevented.

In a further advantageous embodiment of the pressure control valve system, the pressure control valve is a ball check valve. As a result of this, for example, the technical advantage is achieved that good sealing action is achieved simultaneously with a high fuel throughput.

In a further advantageous embodiment of the pressure control valve system, the filling line has a check valve, whose opening direction is opposite to the opening direction of the pressure control valve. As a result of this, for example, the technical advantage is achieved that a passage in the filling line is blocked with a high sealing action in the filling line.

In a further advantageous embodiment of the pressure control valve system, the filling line comprises an orifice element for reducing the flow cross-section of the filling line. As a result of this, for example, the technical advantage is achieved that in a regular operation back-flow of fuel through the orifice element is prevented in such a way that pressure can be maintained in the fuel line without the use of a valve.

In a further advantageous embodiment of the pressure control valve system, the filling line is a capillary line. As a result of this, for example, the technical advantage is achieved that in regular operation the back-flow of the fuel is prevented by the capillary line, instead of by an orifice element or a choke, in such a way that pressure can be maintained in the fuel line without the use of a valve.

In a further advantageous embodiment of the pressure control valve system, the pressure control valve system has a molded component in which the pressure line and the filling line are formed. As a result of this, for example, the technical advantage is achieved that the pressure control valve system can be manufactured with simple means.

In a further advantageous embodiment of the pressure control valve system, the molded part comprises a molded subcomponent in which the first sections of the pressure line and of the filling line are formed, and a second molded subcomponent in which the second sections of the pressure line and of the filling line are formed. As a result, for example, the technical advantage is achieved that the two parts can be separated from one another in order to make accessible the inside of the pressure control valve system.

In a further advantageous embodiment of the pressure control valve system, the pressure control valve system has a housing, wherein the molded part can be inserted into the housing or into an integral element of the housing. As a result of this, for example, the technical advantage is achieved that the pressure control valve system can be manufactured modularly or in a compact structural form.

In a further advantageous embodiment of the pressure control valve system, the pressure control valve system has a housing with a connection for the filling line. As a result of this, for example, the advantage is achieved that the fuel line can be filled with fuel through a separate connection.

In a further advantageous embodiment of the pressure control valve system, the pressure control valve has a valve head that can be pressed with a spring against a valve seat. As a result of this, for example, the technical advantage is achieved that the pressure control valve can be constructed with simple technical means and a high sealing action can be achieved with the valve head.

In a further advantageous embodiment of the pressure control valve system, the filling line has an orifice with a replaceable plate element with an opening. As a result of this, for example, the technical advantage is achieved that a flow cross-section can be set with the aid of the opening.

In a further advantageous embodiment of the pressure control valve system, the filling line has a filter element for filtering the fuel. As a result of this, for example, the technical advantage is achieved that clogging of the filling line is prevented.

In a further advantageous embodiment of the pressure control valve system, the pressure control valve has a housing with a first housing part and a second housing part. As a result of this, for example, the technical advantage is achieved that the manufacturing process is simplified or that the housing can be opened if needed.

In a further advantageous embodiment of the pressure control valve system, the pressure control valve system has a first connecting piece and a second connecting piece for closing a fuel line. As a result of this, for example, the technical advantage is achieved that the pressure control valve system can be integrated into a fuel line in a simple manner.

In a further advantageous embodiment of the pressure control valve system, the first connecting piece runs displaced parallel to the second connecting piece. As a result of this, for example, the technical advantage is achieved that the pressure control valve system can be constructed in a space-saving manner and with few parts.

In a further advantageous embodiment of the pressure control valve system, the first connecting piece and the second connecting piece run along the same axis. As a result of this, for example, the technical advantage is achieved that a low flow resistance is achieved.

In a further advantageous embodiment of the pressure control valve system, the pressure line runs along the same axis as the first connecting piece and the second connecting piece. As a result of this, for example, again the technical advantage is achieved that a low flow resistance is achieved.

In a further advantageous embodiment of the pressure control valve system, the filling line runs displaced parallel to the pressure line. As a result of this, for example, the technical advantage is achieved that a straight flow can be realized in the pressure line.

### BRIEF DESCRIPTION OF THE DRAWINGS

Practical examples of the invention are represented in the drawing and are described in more detail below.

The following are shown:

FIG. 1 is a cross-sectional view of a first embodiment of the pressure control valve system;

FIG. 2 is a further cross-sectional view of a second embodiment of the pressure control valve system;

FIG. 3 is a further cross-sectional view of third embodiment of the pressure control valve system;

FIG. 4 is a further cross-sectional view of a fourth embodiment of the pressure control valve system;

FIG. 5 shows various views of a check valve; and

FIGS. 6a , 6b, and 6c are further views of different embodiments of check valves; and

FIG. 7 is a further cross-sectional view and a view of a fifth embodiment of the pressure control valve system

### DETAILED DESCRIPTION

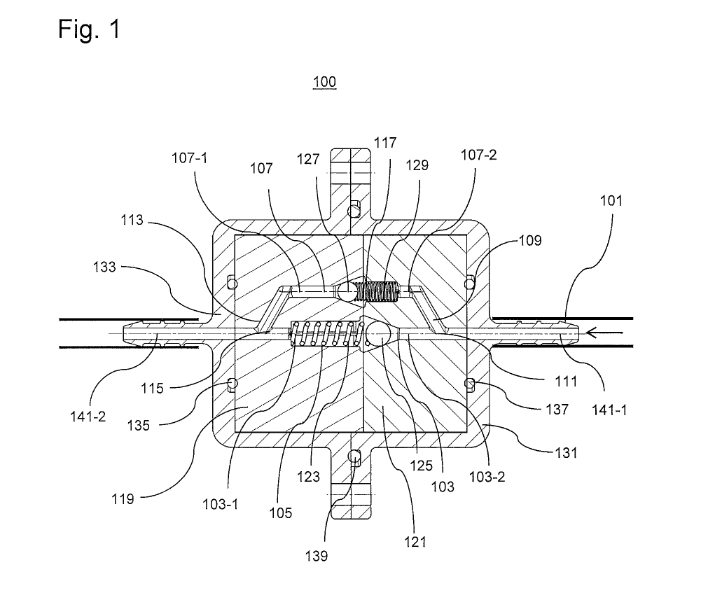

FIG. 1 shows a cross-sectional view of a first embodiment of the pressure control valve system 100. The pressure control valve system 100 is connected to a fuel line 101 through which the uncombusted fuel runs back into a fuel cycle from an internal combustion engine, which is not shown. For this reason, this fuel line 101 is also called the leak oil line. The pressure control valve system 100 serves for maintaining pressure in the fuel line 101.

The pressure control valve system 100 is especially suited to maintaining the pressure constant in the return from an internal combustion engine with piezo-injection valves in a common rail system, such that the function of the piezo-injection valves is maintained and pressure fluctuations at the injection nozzles are prevented. A common rail system designates a diesel direct injection internal combustion engine in which all cylinders lie on a common fuel distributor line. In this distributor line a permanently high pressure is produced, and the fuel is stored and distributed to the controlled injection nozzles. The advantages of the common rail system are better mixture formation in the cylinders, lower consumption, and lower emissions.

The pressure control valve system 100 comprises a pressure line 103 through which the fuel flows in the direction of the arrow when a predetermined pressure is exceeded. The pressure line 103 is formed by a straight flow channel inside the pressure control valve system 100.

The pressure control valve 105 serves to maintain and stabilize the pressure. The pressure control valve 105 is formed by a check valve with a spring 123 that presses a sphere 125 into a funnel-shaped valve seat. The pressure in the fuel line 101 is established by the spring constant and by the pre-tension of the spring 123. When the pressure in the fuel line 103 exceeds a target value defined by the spring 123, the pressure control valve 105 opens, so that fuel can flow out from the fuel line 101 and the pressure in the fuel line 101 becomes reduced until the target value is reached again.

In the manufacture of the vehicle or after maintenance or repair, it is frequently necessary to perform an initial filling or refilling of the fuel line 101 with fuel. The initial filling or refilling with fuel is done in a filling direction that is opposite to the direction of the arrow that gives the main direction of flow of the fuel during the operation of the internal combustion engine. For the purpose of filling the fuel line 101 a filling line 107 is provided, which comprises another check valve 117 loaded with a spring 129. The spring 129 presses the sphere 127 into a funnel-shaped valve seat that is formed in the filling line 107. The inlet 113 of the filling line 107 is connected to the exit 115 of the pressure line, while the exit 109 of the filling line 107 is connected to the inlet 111 of the pressure line.

During the filling of the fuel line 101, valve 117 opens and the fuel can flow through the filling line 107 into the fuel line 101. For the filling of the fuel line 101 with the injection valves, the branch of the filling line 107 with the check valve 117, which has a smaller sphere 127 than the one in pressure line 103, is used.

In the filling direction, the fuel acts as fluid with pressure on the sphere 125 in the pressure line 103 and thus seals the passage. At the same time, the fuel acts with the same pressure on the sphere 127 of the filling line 107 and opens the valve 117. When the pressure exceeds a predetermined pressure, such as, for example, an opening pressure of 0.6 bar, the sphere 127 lifts up from the sphere seat and opens valve 117, so that filling of the fuel line 101 occurs.

In the direction opposite to the main flow, the fuel acts as fluid with pressure on the sphere 127 and presses the sphere 127 against the seat of the seal in filling line 107 so that sealing occurs. In addition, the fuel acts on the sphere 125 in the pressure line 103 with the same pressure. If the pressure exceeds the opening pressure of, for example, 14 bar to 17 bar, then the sphere 125 lifts up from its seat and opens the valve 105. The fuel flows from the fuel line 101 through the pressure control valve system 100.

Thus, the pressure control valve system 100 comprises two valves 105 and 117 which are arranged opposite one another from the point of view of fluid technology, of which one opens in the direction of the fuel line 101 and the other opens in the direction of a preliminary run line. Opening or closing of the valves is done with the aid of spheres 125 and 127 as closing bodies. The pressure control valve system 100 can therefore open in two opposite directions with flow technology. Therefore, the valves 105 and 117 open depending on the opening pressure and holding pressure in the system in the one or the other direction so that two flow directions can be realized.

The pressure line 103 and the filling line 107 are formed as fluid channels in the two molded parts 119 and 121. The two molded parts 119 and 121 have, for example, a cylindrical shape, in the middle of which a channel runs for the pressure line 103. The channel for the filling line 107 goes around the pressure control valve 105 and is formed on the side in the molded bodies 119 and 121. The pressure control valves 105 and 117 are formed by recesses in the molded parts 119 and 121, in which the springs 123 and 129 as well as the spheres 125 and 127 are placed. The pressure control valves 105 and 117 are therefore formed by the cooperation of the two molded parts 119 and 121. Each of the valves 105 and 117, with the sphere side and the spring side is thus formed in one of the molded parts 119 or 121.

The molded part 119 has a first section 103-1 of the pressure line 103 and a first section 107-1 of the filling line 107. In addition, in the molded part 119, a cylindrical recess is formed for the seat of the spring 123 of the pressure control valve 105 and a funnel-shaped recess for the seat of sphere 127. The molded part 121 has a second section 103-2 of the pressure line 103 and a second section 107-2 of the filling line 107. In addition, in the molded part 121, a cylindrical recess is formed for the seat of the spring 129 of the pressure control valve 117 and a funnel-shaped or cone-shaped recess for the seat of the sphere 125. The ridges formed in the respective recess guide the springs 123 and 129 and prevent kinking or tilting during the opening process.

In general, the two molded parts 119 and 121 may have any other form besides the cylindrical form and can be connected to one another in any arbitrary way; for example, they can be welded together. In another embodiment, a one-part molded body can be used.

The two molded parts 119 and 121 are arranged in a housing 131, 133, which encloses them completely and has connections for the fuel line 101 and the preliminary run. The housing comprises the two housing parts 131 and 133, which can be screwed together. For this purpose, one of the housing parts 131 has an outer thread, which is not shown, and the other of the housing parts 133 has an inner thread, which can be turned into each other.

A circumferential seal 139 is arranged between the two housing parts 131 and 133, which prevents the fuel from leaking from the inside of the pressure control valve system 100 to the outside. In addition, between the molded part 119 and the housing part 133 and between the molded part 121 and the housing part 131, additional seals 135 and 137 are arranged, which can be sealing rings, for example, which also prevent the leakage of the fuel to the outside.

In general, the two housing parts 131 and 133 may have any other suitable shape and can be connected to one another in any arbitrary manner; for example, they can be welded together.

The housing of the pressure control valve system 100 has two connections or connecting pieces 141-1 and 141-2, which serve to connect the pressure control valve system 100 to a fuel line 101, so that when there is an excess pressure, the fuel can flow through the pressure control valve system 100. In an alternative embodiment, a third separate connection can be provided in the housing, which is connected to the filling line 107, and which is provided exclusively for filling the fuel line.

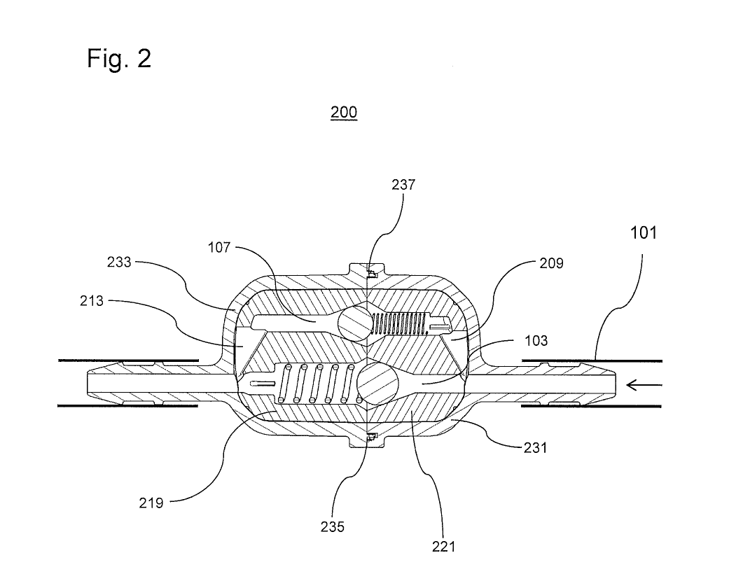

FIG. 2 shows another cross-sectional view of a second embodiment of the pressure control valve system 200. The pressure control valve system 200 shown in FIG. 2 differs from the pressure control valve system 100 shown in FIG. 1 by the more compact construction and a different shape of the molded bodies 219 and 221 and of its housing with housing parts 231 and 233. The pressure line 107 is not formed by a flow channel in the center of the molded bodies 219 and 221 but is displaced in the cross section with respect to the middle of the molded bodies 219 and 221.

The inlet 213 and the outlet 209 of the filling line 107 are formed by recesses in the molded bodies 219 and 221.

The housing parts 231 and 233 form an oval housing with connections for the fuel line 101 and the preliminary run displaced with respect to one another. In one of the housing parts 233, a circumferential spring 237 is formed that engages in a corresponding groove 235 in the other of the housing parts 231.

By displacing the pressure line 103 with respect to the middle of the molded parts 219 and 221, the advantage arises that the pressure control valve system 200 can be manufactured in a more compact construction.

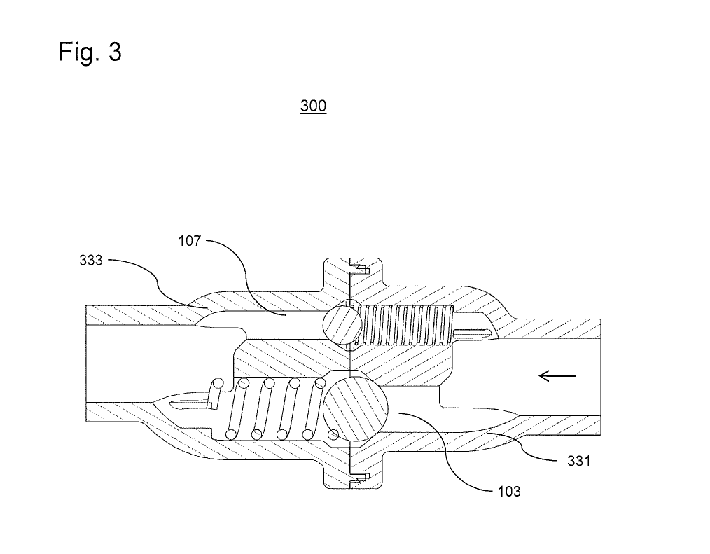

FIG. 3 shows a further cross-sectional view of a third embodiment of the pressure control valve system 300. The pressure control valve system 300 shown in FIG. 3 differs from the pressure control valve systems shown in FIGS. 1 and 2 by the fact that the molded parts for forming the pressure line 103 and the filling line 107 are fused together with the housing and thus form an integral element of the housing. As a result of this, the advantage is achieved that the construction of the pressure control valve system 300 is simplified even further.

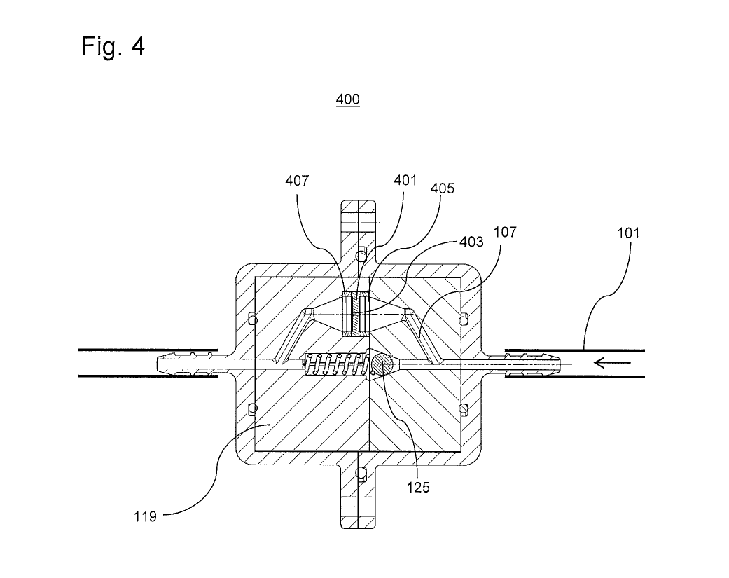

FIG. 4 shows another cross-sectional view of a third embodiment of the pressure control valve system 400. The pressure control valve system 400 shown in FIG. 4 differs from the one shown in FIG. 1 by the fact that the filling line 107 comprises an orifice element 401 with an opening 403 instead of a check valve.

In the direction of filling, the fuel produces a pressure, with which the sphere 125 is pressed against the seat of the sphere in a sealing manner. The fuel flows only through the orifice element 401, the opening 403 of which is adapted to the filling pressure. The fuel line 101 is filled by the fuel flowing through the opening 403. The opening 403 reduces the flow cross-section in the filling line 107.

In a main flow direction, the fuel also applies a pressure onto the orifice element. Therefore, during this process, a small amount of fuel flows through the orifice 403 through the filling line 107. However, in addition, the pressure acts on the sphere 125 in pressure line 103. As soon as the pressure exceeds an opening pressure of, for example, 14 bar to 17 bar, the pressure control valve opens and the reduction of pressure in the fuel line 101 begins. The pressure loss through the opening 403 in the filling line 407 should be negligible in this process.

The orifice element 401 is arranged between two filter elements 405 and 407, for example, small screens, which prevent plugging of the opening 403 of the orifice element 401 by particles in the fuel. The orifice element 401 is set into the molded body 119.

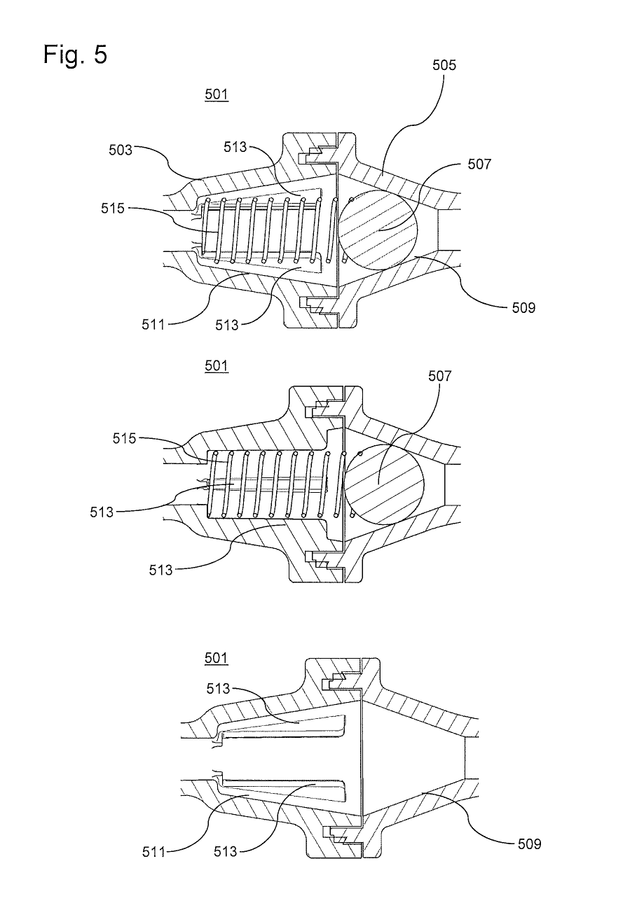

FIG. 5 shows various cross-sectional views of a ball check valve 501. The check valve 501 can be used both in the filling line 107 as well as in the pressure line 103. The pressure control valve 501 includes two housing halves 503 and 505 with a sphere side and a spring side. The two housing halves 503 and 505 can be formed by the molded bodies of the pressure control valve system according to the invention and can be welded together.

The spring seat 511 in the first housing half 503 has a funnel-like or conical shape and serves for accepting spring 515. The sphere seat 509 in the second housing half 505 also has a funnel-like or conical shape and serves for accepting sphere 507, which is held in position by spring 515.

The guide ribs 513 in the spring seat 511 guide and support the spring 515 and prevent kinking.

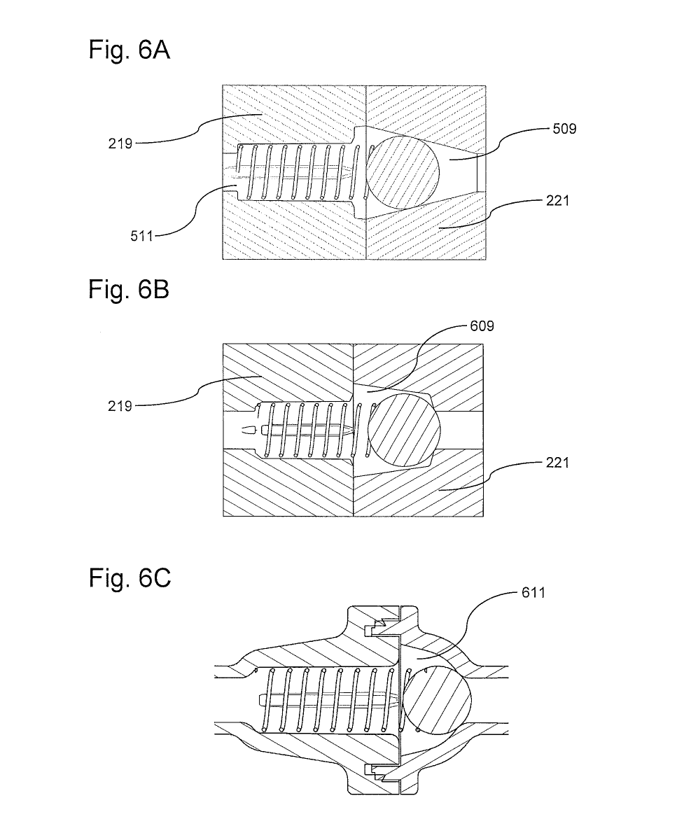

FIGS. 6A-6C show further cross-sectional views of various embodiments of pressure control valves.

FIG. 6A shows the valve explained in connection with FIG. 5, in which the housing parts are formed by the molded bodies 219 and 211.

FIG. 6B shows an embodiment of a check valve in which the sphere seat 609 is cup-shaped.

FIG. 6C shows an embodiment of the check valve in which the sphere seat 611 is bowl-shaped.

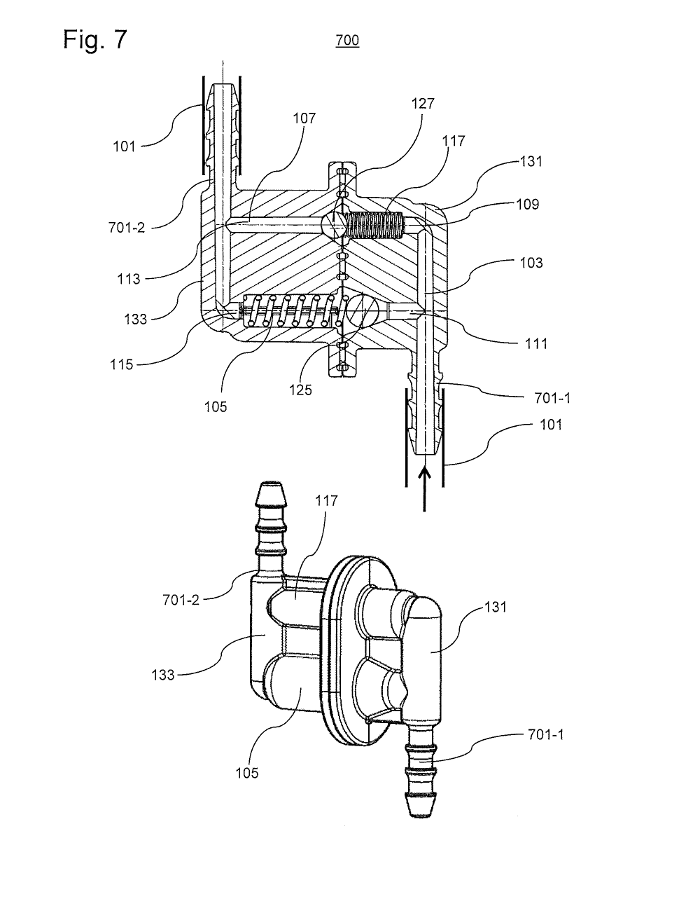

FIG. 7 shows a further cross-sectional view and a view of a fifth embodiment of the pressure control valve system 700. The pressure control valve system 700 shown in FIG. 7 comprises two connecting pieces 701-1 and 701-2 displaced in a parallel direction for connecting to the fuel line 101. As a result of this, the technical advantage is achieved that manufacture of the pressure control valve system 700 is simplified and the pressure control valve system 700 is constructed from a small number of individual parts.

The pressure control valve system 700 comprises a connecting piece 701-1, whose flow direction is arranged perpendicularly to the flow direction within the pressure line 103. Furthermore, the pressure control valve system 700 comprises a second connecting piece 701-1, whose flow direction is also arranged perpendicularly to the flow direction of pressure line 103.

The pressure control valve 105 connects the fuel channel formed from the two connecting pieces 701-1 and 701-2 at a right angle. The check valve 117 is displaced parallel to the pressure control valve 115 and connects the fuel channel formed by the two connecting pieces 701-1 and 701-2 also at a right angle. As a result of this, a double L-shaped or angled flow channel is produced.

The pressure control valve 700 with the connecting pieces 701-1 and 701-2 is also formed by the two housing parts 133 and 131. The other reference numbers refer to components that were already explained in connection with the previous figures.

All the individual characteristics explained in the description and shown in the figures can be combined with one another in any sensible manner and means in order to realize their advantageous effects simultaneously.

The pressure control valve systems described and shown can generally be used in a fuel injection device of an internal combustion engine or for controlling the flow of other fluids.

### REFERENCE LIST

100 Pressure control valve system

101 Fuel line

103 Pressure line

103-1 First section

103-2 Second section

105 Pressure control valve

107 Filling line

107-1 First section

107-2 Second section

109 Outlet

111 Inlet

113 Inlet

115 Outlet

117 Check valve

119 Molded part

121 Molded part

123 Spring

125 Sphere

127 Sphere

129 Spring

131 Housing part

133 Housing part

135 Seal

137 Seal

139 Seal

141-1 Connecting piece

141-2 Connecting piece

200 Pressure control valve system

209 Outlet

213 Inlet

219 Molded body

221 Molded body

231 Housing part

233 Housing part

235 Groove

237 Spring

300 Pressure control valve system

331 Housing part

333 Housing part

400 Pressure control valve system

401 Orifice element

403 Opening

405 Screen

407 Screen

501 Check valve

503 Housing half

505 Housing half

507 Sphere

509 Sphere seat

511 Spring seat

513 Guide ribs

515 Spring

609 Cup-shaped sphere seat

611 Bowl-shaped sphere seat

700 Pressure control valve system

701-1 Connecting piece

701-2 Connecting piece

1. Pressure control valve system for a fuel line, comprising:
a pressure line with a pressure control valve for maintaining a fuel pressure in the fuel line; and
a filling line for filling the fuel line with fuel,
wherein an inlet of the pressure line is connected to an outlet of the filling line using fluid technology.

2. Pressure control valve system according to claim 1, wherein an inlet of the filling line is decoupled from an outlet of the fuel line using fluid technology or an inlet of the filling line is connected to an outlet of the pressure line using fluid technology.

3. Pressure control valve system according claim 1, wherein a flow-through direction of the filling line is disposed opposite to a flow-through direction of the pressure line using fluid technology.

4. Pressure control valve system according to claim 1, wherein the pressure control valve is a ball check valve.

5. Pressure control valve system according to claim 1, wherein the filling line has a check valve having a direction of opening opposite to a direction of opening of the pressure control valve.

6. Pressure control valve system according to claim 1, wherein the filling line has an orifice element to reduce a flow cross-section of the filling line.

7. Pressure control valve system according to claim 1, wherein the filling line is a capillary line.

8. Pressure control valve system according to claim 1, wherein the pressure control valve system has a molded part in which the pressure line and the filling line are formed.

9. Pressure control valve system according to claim 8, wherein the molded part comprises a first molded subcomponent in which first sections of the pressure line and of the filling line are formed, and also comprises a second molded subcomponent in which second sections of the pressure line and of the filling line are formed.

10. Pressure control valve system according to claim 8, wherein the molded part is set into a housing or is an integral element of the housing.

11. Pressure control valve system according to claim 1, wherein the pressure control valve system comprises a first connecting piece and a second connecting piece for connecting a fuel line.

12. Pressure control valve system according to claim 11, wherein the first connecting piece is displaced in a parallel direction with respect to the second connecting piece.

13. Pressure control valve system according to claim 11, wherein both the first connecting piece and the second connecting piece run along a same axis.

14. Pressure control valve system according to claim 13, wherein the pressure line runs along a same axis as the first connecting piece and the second connecting piece.

15. Pressure control valve system according to claim 1, wherein the filling line runs displaced parallel to the pressure line.
